(19) United States
(12) Patent Application Publication
(10) Pub. No.: US 2026/0304222 A1
(43) Pub. Date: Oct. 1, 2026

(54) RECEIVER-BASED REAL-TIME TRANSPORT PROTOCOL DUPLICATION

(71) Applicant: QUALCOMM Incorporated, San Diego, CA (US)

(72) Inventors: Nariman TORKZABAN, San Diego, CA (US); Yubing JIAN, SAN DIEGO, CA (US); Arnaud MEYLAN, San Diego, CA (US); Reza SHAHIDI, La Jolla, CA (US); Leena ZACHARIAS, San Jose, CA (US)

(21) Appl. No.: 19/095,957

(22) Filed: Mar. 31, 2025

(51) Int. Cl. H04W 28/06; H04L 5/00; H04L 43/0829

(52) U.S. Cl. CPC H04W 28/06; H04L 5/0053; H04L 43/0829

(57) ABSTRACT

This disclosure provides methods, components, devices and systems for receiver-based real-time transport protocol (RTP) duplication. A receiving device, which receives transport protocol packets from a transmitting device, may determine whether to start or stop packet duplication and may transmit a trigger signal to start or stop the packet duplication based on receiver-side metrics. The receiving device may measure, for example, one or more of packet loss, latency, or jitter, and transmit a trigger signal to start packet duplication if one or more of the metrics satisfies a threshold. The receiving device may measure these metrics over a sliding window to determine whether to transmit a trigger signal to start packet duplication. If the transmitting device is performing packet duplication, the receiving device may determine when to stop packet duplication. For example, if packet duplication is not improving performance, the receiving device may send a trigger signal to stop packet duplication.

### TECHNICAL FIELD

This disclosure relates generally to wireless communication, and more specifically to systems, devices, methods, and techniques associated with receiver-based real-time transport protocol duplication.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

The systems, methods, and devices of this disclosure each have several innovative aspects, no single one of which is solely responsible for the desirable attributes disclosed herein. The following is a summary of some non-limiting aspects of the disclosure:

A method for wireless communications by a first device is described. The method may include receiving, from a second device, a first set of transport protocol packets during a time window, transmitting, to the second device, a trigger signal for packet duplication based on a trigger to start or stop the packet duplication associated with the time window, and receiving, from the second device, a second set of transport protocol packets in accordance with the packet duplication based on the trigger signal.

A first device for wireless communications is described. The first device may include a processing system that includes processor circuitry and memory circuitry that stores code. The processing system may be configured to cause the first device to receive, from a second device, a first set of transport protocol packets during a time window, transmit, to the second device, a trigger signal for packet duplication based on a trigger to start or stop the packet duplication associated with the time window, and receive, from the second device, a second set of transport protocol packets in accordance with the packet duplication based on the trigger signal.

Another first device for wireless communications is described. The first device may include means for receiving, from a second device, a first set of transport protocol packets during a time window, means for transmitting, to the second device, a trigger signal for packet duplication based on a trigger to start or stop the packet duplication associated with the time window, and means for receiving, from the second device, a second set of transport protocol packets in accordance with the packet duplication based on the trigger signal.

A non-transitory computer-readable medium storing code for wireless communications is described. The code may include instructions executable by one or more processors to receive, from a second device, a first set of transport protocol packets during a time window, transmit, to the second device, a trigger signal for packet duplication based on a trigger to start or stop the packet duplication associated with the time window, and receive, from the second device, a second set of transport protocol packets in accordance with the packet duplication based on the trigger signal.

Some examples of the method, first devices, and non-transitory computer-readable medium described herein may further include operations, features, means, or instructions for detecting the trigger to start or stop the packet duplication based on one or more of a packet loss ratio of the first set of transport protocol packets received during the time window satisfying a first threshold, a latency metric of the first set of transport protocol packets received the time window satisfying a second threshold, or a jitter metric of the first set of transport protocol packets received during the time window satisfying a third threshold.

Some examples of the method, first devices, and non-transitory computer-readable medium described herein may further include operations, features, means, or instructions for measuring one or more metrics associated with starting the packet duplication over a sliding time window when the packet duplication may be not activated, where the trigger to start the packet duplication may be based on the one or more metrics.

Some examples of the method, first devices, and non-transitory computer-readable medium described herein may further include operations, features, means, or instructions for measuring one or more metrics associated with stopping the packet duplication over a sliding time window when the packet duplication may be activated, where the trigger to stop the packet duplication may be based on the one or more metrics.

Some examples of the method, first devices, and non-transitory computer-readable medium described herein may further include operations, features, means, or instructions for transmitting a second trigger signal to stop the packet duplication based on a second trigger associated a second time window, where the second set of transport protocol packets may be received during the second time window.

Some examples of the method, first devices, and non-transitory computer-readable medium described herein may further include operations, features, means, or instructions for detecting the second trigger based on one or more of a decrease to a packet loss ratio failing to satisfy a first threshold during the second time window, a decrease to a latency metric failing to satisfy a second threshold during the second time window, or a decrease to a jitter metric failing to satisfy a third threshold during the second time window.

Some examples of the method, first devices, and non-transitory computer-readable medium described herein may further include operations, features, means, or instructions for determining, for a first duplication of the second set of transport protocol packets associated with a primary network path, a first set of metrics associated with the primary network path based on the packet duplication, determining, for a second duplication of the second set of transport protocol packets associated with a secondary network path, a second set of metrics associated with the secondary network path based on the packet duplication, and detecting the second trigger based on the first set of metrics and the second set of metrics.

### BRIEF DESCRIPTION OF THE DRAWINGS

FIG. 1 shows an example of a wireless communication system.

FIG. 2 shows an example of a signaling diagram that supports receiver-based real-time transport protocol (RTP) duplication.

FIG. 3 shows an example of a sliding window configuration that supports receiver-based RTP duplication.

FIG. 4 shows an example of a process flow that supports receiver-based RTP duplication.

FIG. 5 shows a block diagram of a processing system that supports receiver-based RTP duplication.

FIG. 6 shows a diagram of a system including a device that supports receiver-based RTP duplication.

FIGS. 7 through 9 show flowcharts illustrating methods that support receiver-based RTP duplication.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communications systems that support transport protocol communications, such as real-time transport protocol (RTP) communications, may support packet duplication to reduce packet loss and latency. With packet duplication, an initiator (e.g., transmitting) device may send packets via a first network path, such using as an Internet Protocol (IP) multimedia subsystem (IMS) network, and send duplications of the packets via a second network path, such as over Wi-Fi using the internet. In some systems, the transmitter may enable or disable packet duplication based on feedback from the receiver. For example, for RTP duplication the receiver may transmit an RTP control protocol (RTCP) report for RTP duplication indicating a media quality metric to the transmitter, and the transmitter may determine whether to start or stop RTP duplication based on the media quality metric. This control protocol signaling, such as RTCP signaling, may have a longer periodicity, which may lead to delays between performance degradation and implementing packet duplication. Additionally, current mechanisms to enable and disable packet duplication, such as RTP duplication, are based on metrics which may have limited correlation to user experience (e.g., mean opinion score (MOS)).

Aspects of the subject matter described in this disclosure relate to receiver-based packet duplication. For example, a receiving device (e.g., which receives transport protocol packets from a transmitting device) may determine whether to start or stop packet duplication and may transmit a trigger signal to start or stop the packet duplication based on receiver-side metrics. The receiving device may measure, for example, packet loss, latency, or jitter, and transmit a trigger signal to start packet duplication if one or more of the metrics satisfies a threshold. The receiving device may measure these metrics over a sliding window to determine when to transmit a trigger signal (e.g., a start command) to start packet duplication with low latency. Based on receiving the trigger signal to start packet duplication, the transmitting device may begin transmitting duplicates of the packets via a secondary network path. If the transmitting device is performing packet duplication, the receiving device may determine when to stop packet duplication. For example, if packet duplication is not improving performance, the receiving device may send a trigger signal (e.g., a stop command) to stop packet duplication. In some examples, if performance on the primary network path, for example based on packet loss, jitter, or latency metrics, satisfies a threshold while packet duplication is active, the receiving device may send the stop command to the transmitting device to stop packet duplication.

Particular aspects of the subject matter described in this disclosure can be implemented to realize one or more of the following potential advantages. In some examples, by triggering packet duplication via a receiving device, the described techniques can be used to start packet duplication faster than techniques which start packet duplication based on transmitter-side metrics. For example, the receiving device may obtain real-time end-to-end performance metrics for a set of packets and send a stop command when the real-time end-to-end performance metrics satisfy a threshold, which may occur between control signaling periods (e.g., RTCP report instances) of current techniques. Additionally, using receiver-side metrics to enable or disable packet duplication may provide improved user experience, as the receiver-side metrics used to trigger packet duplication (e.g., packet loss ratio, end-to-end latency index, and jitter) may have a higher correlation with user experience. While these techniques are generally described with reference to RTP, these techniques may be implemented to provide similar advantages for other transport protocols.

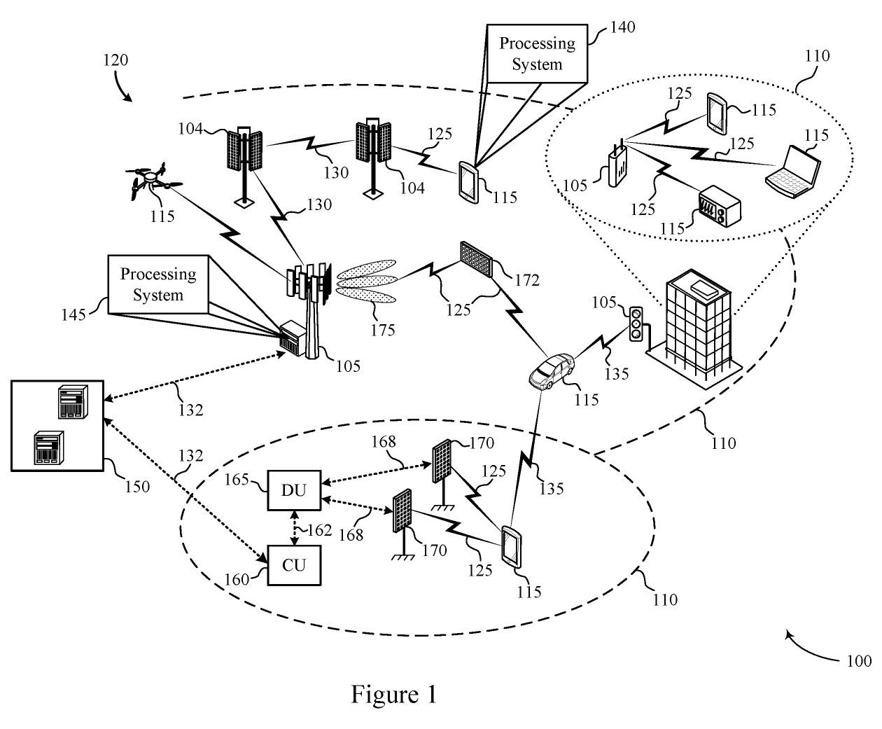

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

A wireless communications system may support RTP duplication to improve RTP packet loss and coverage. In some wireless communications systems, a transmitting device may determine whether to perform RTP packet duplication. For example, the transmitting device may determine whether to activate or deactivate RTP duplication based on cell quality and media quality. The transmitting device may measure a downlink RSRP from a serving cell and compare the downlink RSRP (e.g., cell quality metric) to a threshold. A media quality metric may correspond to a filtered function that maps jitter and loss from an RTCP report to different media quality classes (e.g., bad, good, or excellent). The transmitting device may determine to activate RTP packet duplication, if RTP packet duplication is not already enabled, if the downlink RSRP fails to satisfy a first threshold or if a media quality metric for RTP packets (e.g., reported by a receiving device of the RTP packets via an RTCP report) is reported as bad. The transmitting device may determine to deactivate RTP packet duplication, if RTP packet duplication is enabled, if the downlink RSRP satisfies a second threshold or if a media quality metric for RTP packets (e.g., reported by a receiving device of the RTP packets via an RTCP report) is reported as not bad (e.g., good or excellent).

If the transmitting device enables RTP packet duplication, the transmitting device may transmit RTP packets to the receiving device via a first network path and duplicates of the RTP packets to the receiving device via a second network path. In some examples, the first network path may correspond to an IMS network. In some examples, the second network path may correspond to the Internet. Making use of the duplicate packets may be dependent on the receiving device, without the transmitting device having additional input.

The metrics (e.g., downlink RSRP and media metrics) used to enable or disable RTP duplication in some wireless communications systems may be insufficient. These metrics may have limited correlation with MOS score, which may correspond to user experience. For example, RSRP and media quality metrics may have limited correlation to RTP loss, which is one of the main metrics used to predict MOS. Metrics which do correlate with MOS score may be unavailable at the transmitting device.

Additionally, or alternatively, these metrics may have a lack of real-time availability. Media quality metrics is not available in real-time, as the media quality metric is determined based on loss and jitter metrics from a last RTCP report. Thus, the media quality metrics are only available to be updated based on a periodicity of the RTCP report. In some cases, a receiving device may transmit an RTCP report every five seconds, which may introduce significant delay between performance degradation and activating RTP duplication. Some metrics used to activate or deactivate RTP duplication may be compared to fixed thresholds, which may reduce flexibility for RTP duplication. For example, media quality metrics used for RTP duplication in some wireless communications systems may be compared to fixed thresholds, which may sacrifice smoothness of media quality estimation and compromise accuracy of RTP duplication enablement and disablement.

The wireless communication system 100 may support techniques for receiver-based RTP duplication. For example, a receiving device (e.g., which receives RTP packets from a transmitting device) may determine whether to start or stop RTP duplication. The receiving device may transmit a trigger signal to start or stop the RTP duplication based on receiver-side metrics. The receiving device may measure, for example, packet loss, latency, jitter, or any combination thereof, and transmit a trigger signal to start RTP packet duplication if one or more of the metrics satisfies a threshold. The receiving device may measure these metrics over a sliding window to determine when to transmit a trigger signal (e.g., a start command) to start RTP packet duplication with low latency. Based on receiving the trigger signal to start RTP packet duplication, the transmitting device may begin transmitting duplicates of the RTP packets via a primary network path and a secondary network path. When the transmitting device is performing RTP packet duplication, the receiving device may determine when to stop RTP packet duplication. For example, if RTP packet duplication is not improving performance, the receiving device may send a trigger signal (e.g., a stop command) to stop RTP packet duplication. In some examples, if performance, for example based on packet loss, jitter, or latency metrics, on the primary network path satisfies a threshold, the receiving device may send the stop command to the transmitting device to stop RTP packet duplication.

Devices of the wireless communication system 100 may be configured to support one or more aspects of the described techniques for receiver-based RTP duplication. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support faster activation and deactivation of RTP duplication. Additionally, RTP duplication may be enabled based on receiver-side metrics, which may have a higher correspondence to user experience metrics (e.g., MOS).

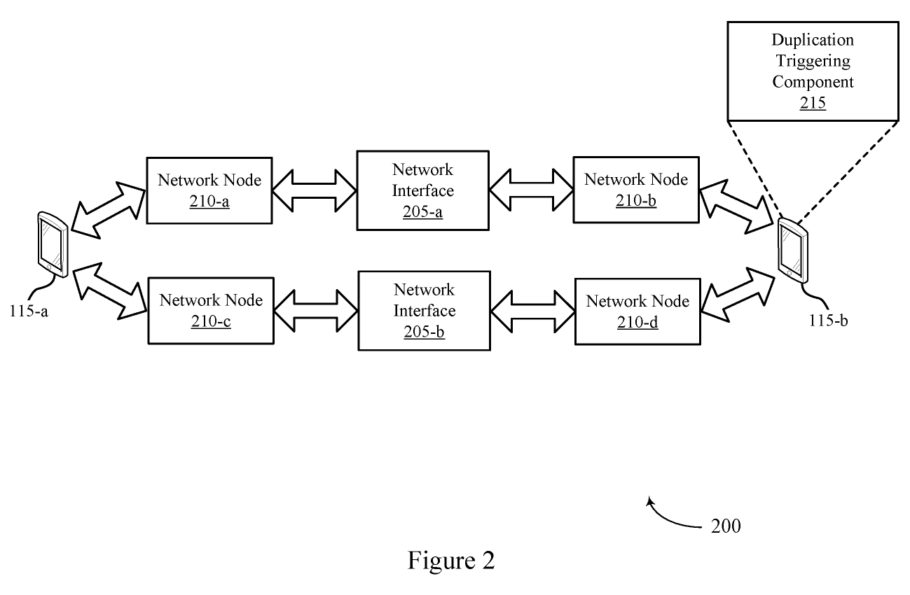

FIG. 2 shows an example of a signaling diagram 200 that supports receiver-based RTP duplication. The signaling diagram may include aspects of a wireless communication system 100. For example, the signaling diagram 200 may include a UE 115-a and a UE 115-b, which may be examples of a UE 115 described herein.

The UE 115-a and the UE 115-b may communicate transport protocol packets via a first network interface 205-a or a second network interface 205-b, or both. The first network interface 205-a may include aspects of an IMS network. For example, the UE 115-a may transmit transport protocol packets, such as RTP packets, to a network node 210-a, and the network node 210-a may send the RTP packets to a network node 210-b via the first network interface 205-a. The network node 210-b may transmit the RTP packets to the UE 115-b. Communications between the UE 115-a and the UE 115-b via the first network interface 205-a may be referred to being communicated via a primary network path. In some examples, the network node 210-a and the network node 210-b may each be an example of a network entity 105 described herein. Additionally, or alternatively, the network node 210-a and the network node 210-b may each be an example of an access point for Wi-Fi communications.

The signaling diagram 200 may support techniques for packet duplication of transport protocol packets, such as RTP duplication for RTP packets. When RTP duplication is enabled, the UE 115-a may transmit RTP packets to the UE 115-b via a primary path (e.g., via the first network interface 205-a) and a secondary path (e.g., via the second network interface 205-b). For example, the UE 115-a may transmit duplicates of RTP packets to a network node 210-c, which are then communicated via the second network interface 205-b to a network node 205-d, and the network node 205-d may transmit the duplicates of the RTP packets to the UE 115-b. In some examples, the network node 210-c and the network node 210-d may each be an example of a network entity 105 described herein. Additionally, or alternatively, the network node 210-c and the network node 210-d may each be an example of an access point, such as an access point for Wi-Fi communications. For example, the second network interface 205-b may be the Internet.

With packet duplication, the UE 115-b may receive transport protocol packets via a primary network path and duplicates of the transport protocol packets via a secondary network path. Packet duplication may improve performance, as any packets lost via the primary path may be received via the secondary path. In some examples, the primary path and the secondary path may have a same radio interface. For example, the primary network path may be an IMS-cellular path, and the secondary network path may be an Internet-cellular path. In some other examples, the primary network path and the secondary network path may each be associated with WiFi communications.

In some wireless communications systems, only a transmitting device, such as the UE 115-a, may enable packet duplication. The signaling diagram 200 may support techniques for a receiving device, such as the UE 115-b, to enable or disable packet duplication. While the techniques herein are generally described with reference to RTP communications and RTP duplication, these techniques may be implemented for other transport protocols or duplication techniques.

For example, the UE 115-b transmit a trigger signal to the UE 115-a to enable or disable packet duplication, such as RTP duplication. The UE 115-b may be equipped with duplication control logic, such as a duplication triggering component 215. The UE 115-a and the UE 115-b may communicate via a reliable command exchange protocol for starting and stopping duplication. Once the receiver (e.g., the UE 115-b) detects conditions to start duplication, the receiver may send a trigger signal (e.g., a ‘START’ command) to the transmitted to start sending the duplicate packets. In some examples, the transmitter may acknowledge the received message including the trigger signal. In some examples, if the receiver does not receive the acknowledgement, the receiver may send another trigger signal.

For example, the UE 115-a may transmit transport protocol packets to the UE 115-b via a primary network path (e.g., via the first network interface 205-a). The UE 115-b may detect that conditions are met to begin packet duplication. The UE 115-b may transmit a trigger signal to the UE 115-a via the reliable command exchange indicating to start RTP duplication. The trigger signal may, for example, include a start command. In some examples, the UE 115-a may acknowledge the trigger signal. The UE 115-a may begin transmitting duplicate RTP packets via a secondary network path (e.g., via the second network interface 205-b).

In some examples, the receiver (e.g., the UE 115-b) may determine that duplication is no longer required. For example, the receiver may determine that duplication is not improving metrics for the transport protocol packets, or the receiver may determine that packets received via the primary network path are sufficient. The receiver may send a trigger signal (e.g., a ‘STOP’ command) to the transmitter to stop sending duplicate packets. In some examples, the transmitter may acknowledge the trigger signal indicating to stop packet duplication. In some examples, if the receiver does not receive the acknowledgement, the receiver may transmit another trigger signal to stop duplication.

The UE 115-b may evaluate receiver-side metrics to determine when to start or stop packet duplication. For example, the UE 115-b may determine local downlink, end-to-end network, and per-packet metrics (e.g., statistics), and the UE 115-b may track changes to the metrics over time via a sliding time window. If, for example, the UE 115-b detects poor performance, the UE 115-b may trigger packet duplication.

In some examples, the receiver-side metrics may include a packet loss ratio. The packet loss ratio may correspond to a ratio of a total number of packets marked as lost (e.g., an RTP loss) over a total quantity of packets. For example, if 100 RTP packets are transmitted and 20 RTP packets are lost (e.g., undecodable or not received), the RTP loss ratio may be 20%. In some examples, packet loss may be extended to playout time, which may account for extended degradation due to packets that miss playout multiple times. An additional, or alternative, receiver-side metric may be a latency index. The latency index may be an end-to-end latency sample statistic corresponding to the set of packets which are not lost.

In some examples, the UE 115-b may determine a real-time trigger metric based on the receiver-side metrics to determine when to start duplication. For example, the UE 115-b may use one or more of a packet loss ratio, latency metric, or jitter metric over the sliding time window to determine a real-time trigger metric. If the real-time trigger metric satisfies a threshold, the UE 115-b may determine to send a trigger signal to start duplication. Upon each time window shift, the UE 115-b may evaluate the receiver-side metrics over the time window against a threshold to determine whether to start duplication.

If packet duplication is active, the UE 115-b may determine whether to disable packet duplication. For example, the UE 115-b may determine whether duplication is required or not based on standalone performance of the primary network path. Additionally, or alternatively, the UE 115-b may determine whether duplication is required, but the current duplication session is not helpful (e.g., is not improving performance of the primary network path). When duplication is active, packets may arrive at the UE 115-b from both the primary network path (e.g., an IMS primary path) and the secondary network path (e.g., an Internet path). If the UE 115-b receives two copies of the same RTP sequence number, statistical information for the earliest arrived packet may, in some cases, only be available for the earliest received packet. Therefore, statistics that are standalone for the primary network path, used to evaluate performance of the primary network path, may not exist.

The UE 115-b may estimate behavior of the primary network path based on virtual statistics of the network paths and comparing the statistics of the primary network path and secondary network path arrivals. For example, the UE 115-b may compare loss metrics or latency metrics, or both, of the primary network path and the secondary network path to determine whether packet duplication is still required or if the secondary network path is improving performance, or both.

For example, while duplication is active, the UE 115-b may measure one or more of loss, latency, jitter, or any combination thereof, for the packets. For example, the UE 115-b may measure metrics over a long time window (e.g., compared to a shorter time window used to determine metrics while duplication is deactivated). Upon each long time window shift, the UE 115-b may determine (e.g., calculate) one or more of an effective packet loss ratio, latency index, jitter, or any combination thereof, over the long time window. For example, the UE 115-b may determine the virtual metrics by enabling to mark the presence or absence of each packet from either network path. Using the presence or absence of each packet from either path, the UE 115-b may estimate a loss ratio, latency performance, jitter, or any combination thereof, of each of the secondary path and the primary path.

The UE 115-b may determine whether RTP redundancy is improving communications performance based on the metrics of the secondary path and the primary path. For example, the UE 115-b may determine, based on the virtual statistics, a percentage of RTP packet losses that is being avoided by receiving duplicates over the secondary path. For example, the UE 115-b may determine a percentage of RTP packets are delivered via the secondary network path and not the primary network path. In some examples, the UE 115-b may determine a metric for latency performance improvement based on the virtual statistics for the secondary network path and the primary network path. In some examples, the UE 115-b may determine a metric for jitter performance improvement based on the virtual statistics for the secondary network path and the primary network path. In some examples, the UE 115-b may determine a redundancy usefulness factor based on improvements to one or more of the packet loss, latency, or jitter from the duplication.

In some examples, the UE 115-a may determine to start duplication, and the UE 115-b may determine whether to stop duplication. For example, the UE 115-a may determine to start RTP duplication based on control signaling (e.g., a media quality metric in an RTCP report) received from the UE 115-b. The UE 115-b may measure metrics of the primary network path and the secondary network path to determine whether to deactivate packet duplication while the packet duplication is active. In other words, the UE 115-b may deactivate packet duplication even if the UE 115-b did not activate the packet duplication.

In some examples, an estimation of the primary network path performance (e.g., without duplicate packets received via the secondary network path) may indicate whether duplication is required or not. For example, if virtual statistics for the primary network path are sufficient (e.g., satisfy one or more thresholds), the UE 115-b may determine that RTP duplication is not required. For example, if the UE 115-b determines that an estimated RTP packet loss metric for the primary network path satisfies a threshold while RTP duplication is activated, the UE 115-b may determine that RTP duplication is not required, and the UE 115-b may transmit a trigger signal (e.g., a ‘stop’ command) to the UE 115-a to stop RTP duplication. In some examples, if metrics for performance improvement based on performing duplication do not satisfy one or more thresholds, the UE 115-b may determine that RTP duplication is not useful or not required. For example, the UE 115-b may determine that latency or jitter metrics are not improved by a threshold amount while RTP duplication is active, and the UE 115-b may transmit a trigger signal (e.g., a ‘stop’ command) to the UE 115-a to stop RTP duplication. For example, the UE 115-a and the UE 115-b may not implement RTP duplication if RTP duplication the UE 115-b does not determine that RTP duplication is useful or improves performance, which may reduce power consumption at the UE 115-a and the UE 115-b and improve resource availability in the signaling diagram 200.

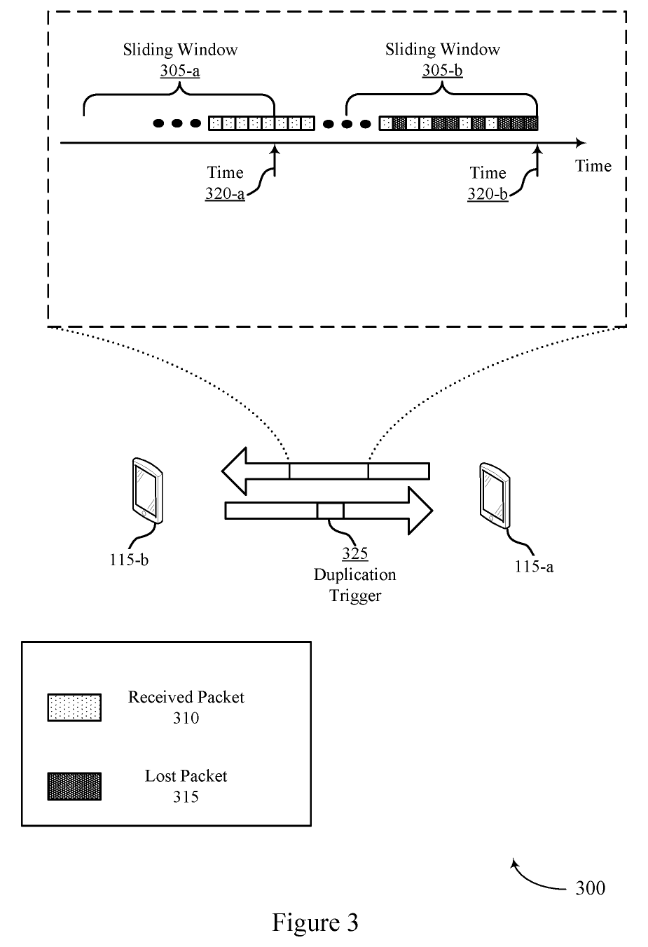

FIG. 3 shows an example of a sliding window configuration 300 that supports receiver-based RTP duplication. The sliding window configuration 300 may implement aspects of a wireless communication system 100 or a signaling diagram 200 described herein. For example, the sliding window configuration 300 may include a UE 115-a and a UE 115-b as described with reference to the signaling diagram 200.

In the example of the sliding window configuration 300, the UE 115-a and the UE 115-b may communicate via a primary network path, such as via a first network interface 205-a as described with reference to FIG. 2. The UE 115-b may receive RTP packets from the UE 115-a via the primary network path and determine whether to start RTP duplication.

The UE 115-b may receive RTP packets and evaluate metrics for the RTP packets over a sliding window 305. For example, the UE 115-b may measure an RTP loss ratio, a latency metric (e.g., a latency index), or a jitter metric, or any combination thereof. If one or more of the metrics for the sliding window 305 satisfies a threshold, the UE 115-b may determine to send a trigger signal to start RTP duplication. In some examples, the sliding window may be an example of a short sliding window. For example, when determining whether to disable RTP duplication, the UE 115-b may evaluate metrics (e.g., estimated or virtual metrics) over a long sliding window, with a longer duration than the short sliding window.

For example, the UE 115-b may evaluate metrics at a time 320-a over a sliding window 305-a. The UE 115-b may determine, for example, an RTP loss ratio of the RTP packets received during the sliding window 305-a. The UE 115-b may determine which RTP packets received in the sliding window 305-a are received RTP packets 310 and which RTP packets received in the sliding window 305-a are lost RTP packets 315. The UE 115-b may determine a ratio of a total number of packets marked as an RTP loss (e.g., a lost RTP packet 315) over all of the RTP packets in the sliding window 305-a. If the ratio satisfies a threshold, the UE 115-b may transmit a trigger signal to start RTP duplication. At the time 320-a, the RTP loss ratio over the sliding window 305-a may not satisfy the threshold, so the UE 115-b may not transmit a trigger signal to start RTP duplication. The UE 115-b may additionally, or alternatively, evaluate other metrics (e.g., latency or jitter) over the sliding window 305-a to determine whether to transmit a trigger signal to start RTP duplication.

The UE 115-b may reevaluate the metrics with each window shift. In some examples, the UE 115-b may determine new metrics with each RTP packet. In some cases, the sliding window 305 may shift after one or more RTP packets, time periods, or transmission time intervals, or any combination thereof. When the sliding window 305 shifts, the UE 115-b may determine new metrics for the new sliding window. The UE 115-b may compare the new metrics for the new sliding window to determine whether to transmit a trigger signal to start RTP duplication.

At time 320-a, the UE 115-b may evaluate metrics over a sliding window 305-b. In some examples, channel conditions may have worsened between the time 320-a and the time 320-b. In some examples, the UE 115-b may determine a packet loss ratio over the sliding window 305-b, and the UE 115-b may determine that a quantity of lost RTP packets 315 over the sliding window 305-b satisfies a threshold. The UE 115-b may transmit an RTP duplication trigger 325 to the UE 115-a to start RTP duplication based on evaluating the metrics over the sliding window 305-b. In some examples, the UE 115-b may additionally, or alternatively, transmit the RTP duplication trigger 325 based on jitter metrics or latency metrics, or both, over the sliding window 305-b. For example, the UE 115-b may determine to transmit the RTP duplication trigger 325 based on local downlink metrics (e.g., downlink RSRP measurements), end-to-end network statistics, per-packet statistics, or any combination thereof.

The RTP duplication trigger 325 may be communicated over a reliable command exchange as described with reference to FIG. 2. In some examples, the RTP duplication trigger 325 may be an example of a ‘start’ command. In some examples, the UE 115-b may transmit the RTP duplication trigger 325 between intervals for an RTCP report. For example, the UE 115-b may transmit the RTP duplication trigger 325 after detecting performance degradation and before a next opportunity to transmit the RTCP report.

The UE 115-a may receive the RTP duplication trigger 325 and begin RTP duplication. For example, the UE 115-a may transmit RTP packets via the primary network path, and the UE 115-a may transmit duplicates of the RTP packets via a second network path. The second network path may include communications over a second network interface, such as a second network interface 205-b as described with reference to FIG. 2.

While RTP duplication is activated, the UE 115-b may measure metrics of the primary network path and the secondary network path. For example, the UE 115-b may determine whether the RTP duplication is improving performance with respect to one or more metrics, including packet loss, jitter, or latency, or a combination thereof. In some examples, the UE 115-b may determine virtual statistics for the primary network path or the secondary network path, or both. The UE 115-b may determine whether the secondary network path is reducing packet loss, latency, or jitter. In some examples, the UE 115-b may determine a redundancy usefulness metric based on comparing statistics (e.g., virtual statistics or estimated statistics) of the primary network path and the secondary network path.

If the UE 115-b determines that duplication is not required or is not improving performance, the UE 115-b may transmit another trigger signal to disable duplication. For example, channel conditions may improve such that a packet loss ratio over the primary network path is below a threshold, and the UE 115-b may transmit the trigger signal to disable duplication. Additionally, or alternatively, the UE 115-b may determine that duplication via the secondary network path is not reducing packet loss above a threshold, and the UE 115-b may transmit the trigger signal to disable duplication. For example, the UE 115-b may determine that the duplicate packets received via the secondary network path are not sufficiently improving performance of the primary network path, and the UE 115-b may disable RTP duplication.

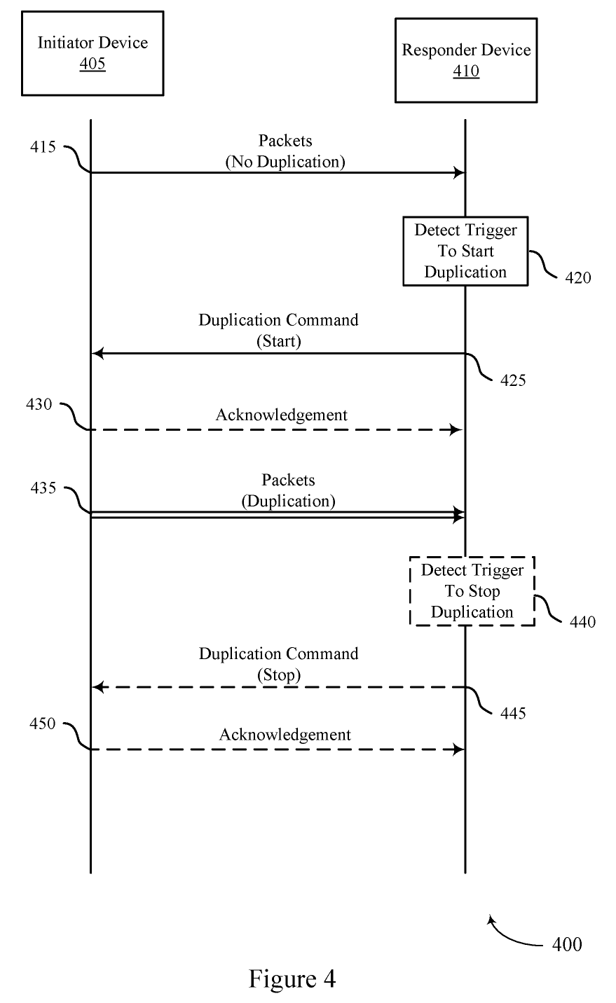

FIG. 4 shows an example of a process flow 400 that supports receiver-based RTP duplication. The process flow 400 may implement, or be implemented by, aspects of the wireless communication system 100, the signaling diagram 200, the sliding window configuration 300, or any combination thereof. The process flow 400 may be implemented by an initiator device 405 and a responder device 410. In some examples, the initiator device 405 and the responder device 410 may each be an example of a UE 115 as described herein. The responder device 410 may be an example of a first device, such as a UE 115-b as described with reference to FIG. 2. The initiator device 405 may be an example of a second device, such as a UE 115-a as described with reference to FIG. 1.

In the following description of the process flow 400, the operations between the initiator device 405 and the responder device 410 may occur in a different order than the example order shown and, in some examples, may be performed by one or more different devices other than those shown as examples. For example, some communications between the initiator device 405 and the responder device 410 may occur over a network path, where the signaling shown between the initiator device 405 and the responder device 410 is transmitted to or communicated between one or more additional devices. Some operations also may be omitted from the process flow 400, and other operations may be added to the process flow 400. Further, although some operations or signaling may be shown to occur at different times for discussion purposes, these operations may actually occur at the same time.

At 415, the initiator device 405 may transmit a first set of transport protocol packets to the responder device 410. The responder device 410 may receive, from the initiator device 405, the first set of transport protocol packets during a time window. In some examples, the responder device 410 may receive the transport protocol packets from the initiator device 405 via a primary network path. For example, the initiator device 405 may transmit the transport protocol packets to a first network node, which communicates the transport protocol packets to a second network node via a network interface. The second network node may transmit the transport protocol packets to the responder device 410. In some examples, the initiator device 405 may transmit the first set of transport protocol packets without packet duplication being activated.

The responder device 410 may measure metrics for the first network path over a sliding window. For example, responder device 410 may measure one or more metrics associated with starting the packet duplication over a sliding time window when the packet duplication is not activated. The metrics may be based on packet loss, latency, or jitter. At 420, the responder device 410 may detect a trigger to start packet duplication. For example, the responder device 410 may detect a trigger to start packet duplication based on one or more of a packet loss ratio of the first set of transport protocol packets received during the time window satisfying a first threshold, a latency metric of the first set of transport protocol packets received the time window satisfying a second threshold, or a jitter metric of the first set of transport protocol packets received during the time window satisfying a third threshold.

At 425, the responder device 410 may transmit a trigger signal to start packet duplication. For example, the responder device 410 may transmit, to the initiator device 405, a trigger signal for packet duplication based on a trigger to start the packet duplication. In some examples, the trigger signal may be an example of a start command. The responder device 410 may transmit the trigger signal to the initiator device 405 via a reliable command exchange or a reliable command exchange interface. In some examples, the initiator device 405 may transmit an acknowledgement for the trigger signal to the responder device 410 at 430

The initiator device 405 may start packet duplication based on receiving the trigger signal to start packet duplication. For example, at 435, the initiator device may transmit packets to the responder device 410 using packet duplication. The initiator device 405 may transmit packets via a primary network path and transmit duplicates of the packets via a secondary network path. The responder device 410 may receive, from the initiator device 405, a second set of transport protocol packets in accordance with the packet duplication based on the trigger signal.

In some examples, the responder device 410 may determine whether to stop packet duplication. The responder device 410 may receive a second set of transport protocol packets in accordance with the packet duplication based on the trigger signal. The responder device 410 may measure one or more metrics associated with stopping the packet duplication over a sliding time window when the packet duplication is activated. For example, the responder device 410 may measure metrics of the second set of transport protocol packets for the primary network path or the secondary network path, or both, over the second time window. The responder device 410 may determine, for a first duplication of the second set of transport protocol packets associated with a primary network path, a first set of metrics associated with the primary network path based on the packet duplication. The responder device 410 may determine, for a second duplication of the second set of transport protocol packets associated with a secondary network path, a second set of metrics associated with the secondary network path based the packet duplication. The responder device 410 may detect a second trigger to stop packet duplication based on the first set of metrics and the second set of metrics at 440.

If, for example, the responder device 410 determines that a decrease to a packet loss ratio fails to satisfy a first threshold during the second time window, a decrease to a latency metric fails to satisfy a second threshold during the second time window, or a decrease to a jitter metric fails to satisfy a third threshold during the second time window, the responder device 410 may detect a trigger to stop packet duplication. For example, the responder device 410 determine a quantity of transport protocol packets of the second set of transport protocol packets that are successfully received via the secondary network path and not the primary network path fails to satisfy a threshold. In some examples, the responder device 410 may determine a quantity of transport protocol packets of the second set of transport protocol packets that are received with an earlier arrival time via the secondary network path than the primary network path, and the responder device 410 may detect the trigger to stop packet duplication based on the quantity of transport protocol packets or a difference in arrival time, or both, satisfying a threshold.

The responder device 410 may transmit a second trigger signal to stop the packet duplication based on a second trigger associated a second time window at 445. For example, the responder device 410 may determine that, in the second time window, duplication is not improving performance or is not required based on estimated metrics for the primary network path or the secondary network path, or both. In some examples, the second trigger signal may include a stop command. The second trigger signal may be communicated via the reliable command exchange. In some examples, the initiator device 405 may transmit an acknowledgement for the second trigger signal at 450.

In some examples, the responder device 410 may transmit a trigger signal to start packet duplication or stop packet duplication. For example, the responder device 410 may transmit a trigger signal to start packet duplication, and the initiator device 405 may determine to stop packet duplication. In some other examples, the initiator device 405 may determine to start packet duplication, and the responder device 410 may determine to stop packet duplication (e.g., and transmit a trigger signal to stop packet duplication).

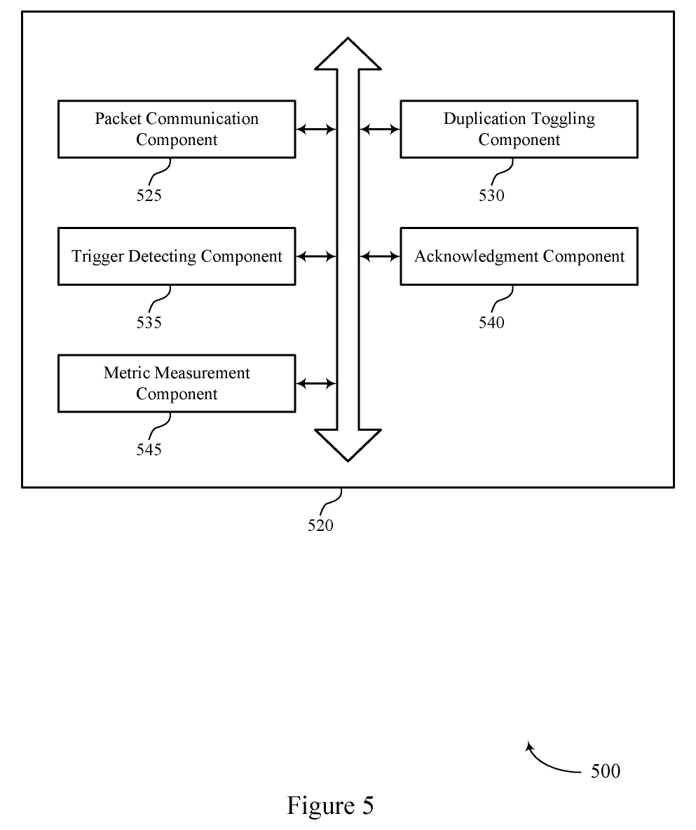

FIG. 5 shows an example of a processing system 520 that supports receiver-based RTP duplication. A processing system 520 may be an example of a processing system 140 (such as of a UE 115) and may include a packet communication component 525, a duplication toggling component 530, a trigger detecting component 535, an acknowledgment component 540, a metric measurement component 545, or any combination thereof. A processing system 520, or various component thereof, may be an example of means for performing (such as a means for causing a UE 115 to perform) various techniques described herein.

The packet communication component 525 may be configured to cause the UE 115 to receive, from a second device, a first set of transport protocol packets during a time window. The duplication toggling component 530 may be configured to cause the UE 115 to transmit, to the second device, a trigger signal for packet duplication based on a trigger to start or stop the packet duplication associated with the time window. In some examples, the packet communication component 525 may be configured to cause the UE 115 to receive, from the second device, a second set of transport protocol packets in accordance with the packet duplication based on the trigger signal.

In some examples, the trigger detecting component 535 may be configured to cause the UE 115 to detect the trigger to start or stop the packet duplication based on one or more of a packet loss ratio of the first set of transport protocol packets received during the time window satisfying a first threshold, a latency metric of the first set of transport protocol packets received the time window satisfying a second threshold, or a jitter metric of the first set of transport protocol packets received during the time window satisfying a third threshold.

In some examples, the trigger detecting component 535 may be configured to cause the UE 115 to measure one or more metrics associated with starting the packet duplication over a sliding time window when the packet duplication is not activated, where the trigger to start the packet duplication is based on the one or more metrics.

In some examples, the trigger detecting component 535 may be configured to cause the UE 115 to measure one or more metrics associated with stopping the packet duplication over a sliding time window when the packet duplication is activated, where the trigger to stop the packet duplication is based on the one or more metrics.

In some examples, the duplication toggling component 530 may be configured to cause the UE 115 to transmit a second trigger signal to stop the packet duplication based on a second trigger associated a second time window, where the second set of transport protocol packets are received during the second time window.

In some examples, the trigger detecting component 535 may be configured to cause the UE 115 to detect the second trigger based on one or more of a decrease to a packet loss ratio failing to satisfy a first threshold during the second time window, a decrease to a latency metric failing to satisfy a second threshold during the second time window, or a decrease to a jitter metric failing to satisfy a third threshold during the second time window.

In some examples, one or more of the packet loss ratio, the latency metric, and the jitter metric for a packet of the second set of transport protocol packets is based on an earlier arrival between the packet received via a primary network path and a duplicate of the packet received via a secondary network path.

In some examples, the metric measurement component 545 may be configured to cause the UE 115 to determine, for a first duplication of the second set of transport protocol packets associated with a primary network path, a first set of metrics associated with the primary network path based on the packet duplication. In some examples, the metric measurement component 545 may be configured to cause the UE 115 to determine, for a second duplication of the second set of transport protocol packets associated with a secondary network path, a second set of metrics associated with the secondary network path based on the packet duplication. In some examples, the trigger detecting component 535 may be configured to cause the UE 115 to detect the second trigger based on the first set of metrics and the second set of metrics.

In some examples, to support detecting the second trigger, the trigger detecting component 535 may be configured to cause the UE 115 to determine a quantity of transport protocol packets of the second set of transport protocol packets that are successfully received via the secondary network path and not the primary network path.

In some examples, to support detecting the second trigger, the trigger detecting component 535 may be configured to cause the UE 115 to determine a quantity of transport protocol packets of the second set of transport protocol packets that are received with an earlier arrival time via the secondary network path than the primary network path, where the quantity of transport protocol packets or a difference in arrival time, or both, satisfies a threshold.

In some examples, the acknowledgment component 540 may be configured to cause the UE 115 to receive an acknowledgement in response to the trigger signal, where the second set of transport protocol packets is received in accordance with the packet duplication based on the acknowledgement.

In some examples, to support receiving the second set of transport protocol packets, the packet communication component 525 may be configured to cause the UE 115 to receive a first duplication of the second set of transport protocol packets via a primary network path. In some examples, to support receiving the second set of transport protocol packets, the packet communication component 525 may be configured to cause the UE 115 to receive a second duplication of the second set of transport protocol packets via a secondary network path that is different from the primary network path.

A processing system 520 may include or be a component of one or more chips, systems-on-chips (SoCs), chipsets, packages, components, or devices that individually or collectively constitute or include a processing system. A processing system 520 may interface with other components of a processing system 520. For example, operations described with reference to a processing system 520, or various components thereof, may be performed by or with other such components, including a receiver, a transmitter, a transceiver, a modem, a user interface, a modulator/demodulator, an encoder/decoder, or any combination thereof (such as of the processing system 520, coupled with the processing system 520, of a processing system 520).

By including or configuring a processing system 520 for operation in a processing system 520 as described herein, the processing system 520 may support techniques for reduced processing, reduced power consumption, and more efficient utilization of communication resources.

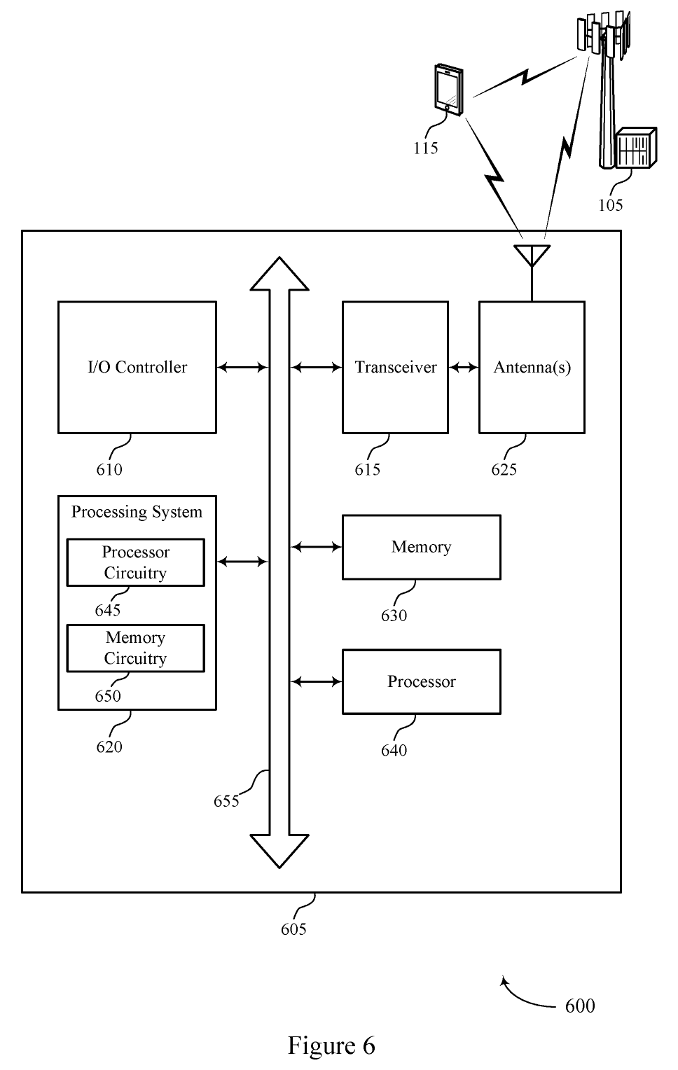

FIG. 6 shows an example of a system 600 including a device 605 that supports receiver-based RTP duplication. The device 605 may be an example of or include components of UE 115. The device 605 may communicate (such as wirelessly) with one or more other devices (such as network entities 105, UEs 115). The device 605 may include components for transmitting and receiving communication, which may include a processing system 620, an input/output (I/O) controller, such as an I/O controller 610, a transceiver 615, antenna(s) 625, a memory 630, and a processor 640. Components of the device 605 may be coupled (such as operatively, communicatively, functionally, electronically, electrically, in electronic communication) a bus 655.

The transceiver 615 may support bi-directional communication via antenna(s) 625, and may support transmission operations, reception operations, or both, as described herein. The transceiver 615 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 605). The transceiver 615 may modulate symbols and provide the modulated symbols to antenna(s) 625 for transmission, and demodulate symbols from signals received using antenna(s) 625.

The processor 640 may be a general-purpose processing component that supports various operations (such as applications) of the device 605. The memory 630 may be a general-purpose storage component that stores code executable by the processor 640. Such code may include instructions that, when executed by the processor 640, cause the device 605 to perform various functions (such as to support an application of the device 605). The I/O controller 610 may manage inputs and outputs for the device 605, may manage peripherals not integrated into the device 605, or may represent a physical connection (such as port) to an external peripheral. The processor 640 may interact with a modem, a keyboard, a mouse, a touchscreen, or other device (such as via I/O controller 610). In some implementations, a user may interact with the device 605 via the I/O controller 610 or via hardware components controlled by the I/O controller 610.

The processing system 620 may be an example of a processing system 140 or a processing system 500. For example, the processing system 620 may include processor circuitry 645 and memory circuitry 650 that stores code, and may be configured to cause the device 605 to perform operations that support receiver-based RTP duplication. Although the processing system 620 is illustrated as a separate component, which may involve a separate chip, chipset, or other module, in some implementations, one or more functions described with reference to the processing system 620 may be supported by or performed by a transceiver 615, antenna(s) 625, a processor 640, memory 630, or any combination thereof, such that a processing system 620 may include one or more of a transceiver 615, antenna(s) 625, a processor 640, memory 630, or any combination thereof.

By including or configuring the processing system 620 for operation in the device 605 as described herein, may support techniques for improved communication reliability, reduced latency, improved user experience, reduced power consumption, more efficient utilization of communication resources, and improved coordination between devices.

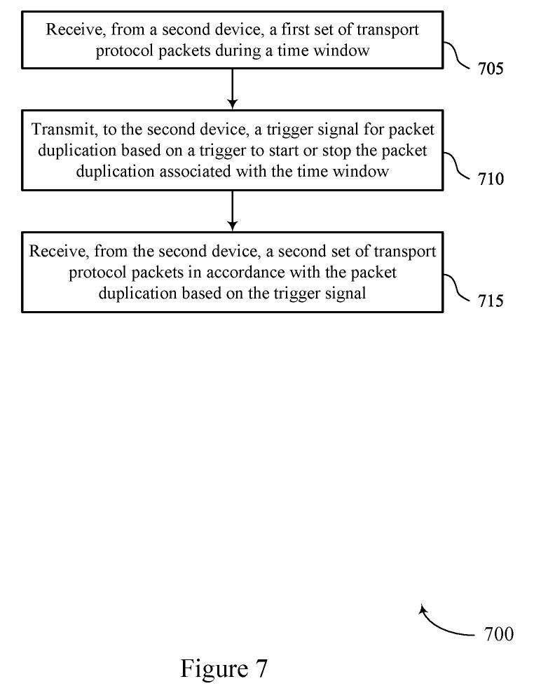

FIG. 7 shows an example of a method 700 that supports receiver-based RTP duplication. Operations of the method 700 may be performed by a UE or its components (such as using a processing system configured to cause the UE 115 to perform one or more of the operations) as described herein.

At 705, the method may include receiving, from a second device, a first set of transport protocol packets during a time window. In some examples, aspects of the operations of 705 may be performed by a packet communication component 525.

At 710, the method may include transmitting, to the second device, a trigger signal for packet duplication based on a trigger to start or stop the packet duplication associated with the time window. In some examples, aspects of the operations of 710 may be performed by a duplication toggling component 530.

At 715, the method may include receiving, from the second device, a second set of transport protocol packets in accordance with the packet duplication based on the trigger signal. In some examples, aspects of the operations of 715 may be performed by a packet communication component 525.

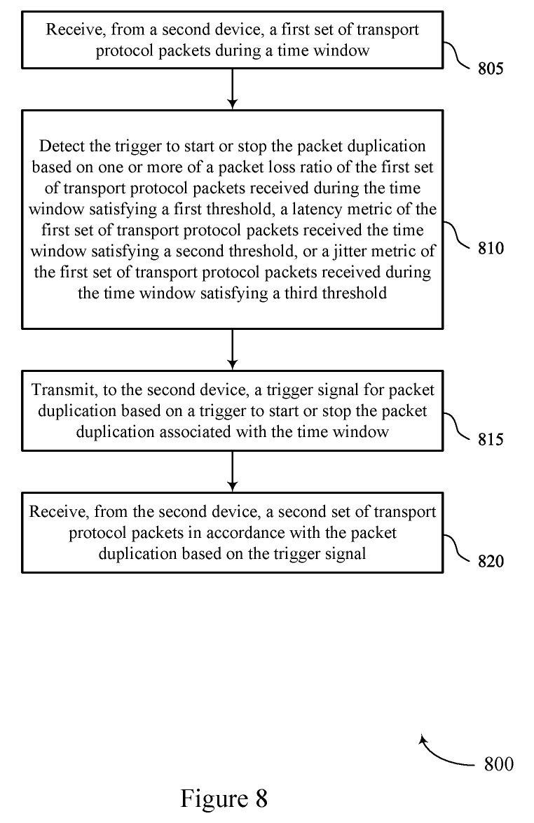

FIG. 8 shows an example of a method 800 that supports receiver-based RTP duplication. Operations of the method 800 may be performed by a UE or its components (such as using a processing system configured to cause the UE 115 to perform one or more of the operations) as described herein.

At 805, the method may include receiving, from a second device, a first set of transport protocol packets during a time window. In some examples, aspects of the operations of 805 may be performed by a packet communication component 525.

At 810, the method may include detecting the trigger to start or stop the packet duplication based on one or more of a packet loss ratio of the first set of transport protocol packets received during the time window satisfying a first threshold, a latency metric of the first set of transport protocol packets received the time window satisfying a second threshold, or a jitter metric of the first set of transport protocol packets received during the time window satisfying a third threshold. In some examples, aspects of the operations of 810 may be performed by a trigger detecting component 535.

At 815, the method may include transmitting, to the second device, a trigger signal for packet duplication based on a trigger to start or stop the packet duplication associated with the time window. In some examples, aspects of the operations of 815 may be performed by a duplication toggling component 530.

At 820, the method may include receiving, from the second device, a second set of transport protocol packets in accordance with the packet duplication based on the trigger signal. In some examples, aspects of the operations of 820 may be performed by a packet communication component 525.

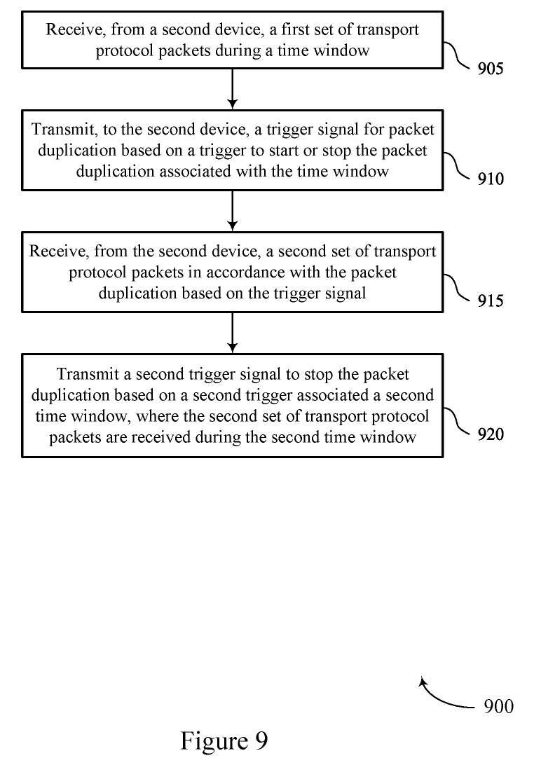

FIG. 9 shows an example of a method 900 that supports receiver-based RTP duplication. Operations of the method 900 may be performed by a UE or its components (such as using a processing system configured to cause the UE 115 to perform one or more of the operations) as described herein.

At 905, the method may include receiving, from a second device, a first set of transport protocol packets during a time window. In some examples, aspects of the operations of 905 may be performed by a packet communication component 525.

At 910, the method may include transmitting, to the second device, a trigger signal for packet duplication based on a trigger to start or stop the packet duplication associated with the time window. In some examples, aspects of the operations of 910 may be performed by a duplication toggling component 530.

At 915, the method may include receiving, from the second device, a second set of transport protocol packets in accordance with the packet duplication based on the trigger signal. In some examples, aspects of the operations of 915 may be performed by a packet communication component 525.

At 920, the method may include transmitting a second trigger signal to stop the packet duplication based on a second trigger associated a second time window, where the second set of transport protocol packets are received during the second time window. In some examples, aspects of the operations of 920 may be performed by a duplication toggling component 530.

### Implementation examples are described in the following numbered clauses

Aspect 1: A method for wireless communications at a first device, comprising: receiving, from a second device, a first set of transport protocol packets during a time window; transmitting, to the second device, a trigger signal for packet duplication based at least in part on a trigger to start or stop the packet duplication associated with the time window; and receiving, from the second device, a second set of transport protocol packets in accordance with the packet duplication based at least in part on the trigger signal.

Aspect 2: The method of aspect 1, further comprising: detecting the trigger to start or stop the packet duplication based at least in part on one or more of a packet loss ratio of the first set of transport protocol packets received during the time window satisfying a first threshold, a latency metric of the first set of transport protocol packets received the time window satisfying a second threshold, or a jitter metric of the first set of transport protocol packets received during the time window satisfying a third threshold.

Aspect 3: The method of any of aspects 1 through 2, further comprising: measuring one or more metrics associated with starting the packet duplication over a sliding time window when the packet duplication is not activated, wherein the trigger to start the packet duplication is based at least in part on the one or more metrics.

Aspect 4: The method of any of aspects 1 through 3, further comprising: measuring one or more metrics associated with stopping the packet duplication over a sliding time window when the packet duplication is activated, wherein the trigger to stop the packet duplication is based at least in part on the one or more metrics.

Aspect 5: The method of any of aspects 1 through 4, further comprising: transmitting a second trigger signal to stop the packet duplication based at least in part on a second trigger associated a second time window, wherein the second set of transport protocol packets are received during the second time window.

Aspect 6: The method of aspect 5, further comprising: detecting the second trigger based at least in part on one or more of a decrease to a packet loss ratio failing to satisfy a first threshold during the second time window, a decrease to a latency metric failing to satisfy a second threshold during the second time window, or a decrease to a jitter metric failing to satisfy a third threshold during the second time window.

Aspect 7: The method of aspect 6, wherein one or more of the packet loss ratio, the latency metric, and the jitter metric for a packet of the second set of transport protocol packets is based at least in part on an earlier arrival between the packet received via a primary network path and a duplicate of the packet received via a secondary network path.

Aspect 8: The method of any of aspects 5 through 7, further comprising: determining, for a first duplication of the second set of transport protocol packets associated with a primary network path, a first set of metrics associated with the primary network path based at least in part on the packet duplication; determining, for a second duplication of the second set of transport protocol packets associated with a secondary network path, a second set of metrics associated with the secondary network path based at least in part on the packet duplication; and detecting the second trigger based at least in part on the first set of metrics and the second set of metrics.

Aspect 9: The method of aspect 8, wherein detecting the second trigger comprises: determining a quantity of transport protocol packets of the second set of transport protocol packets that are successfully received via the secondary network path and not the primary network path.

Aspect 10: The method of any of aspects 8 through 9, wherein detecting the second trigger comprises: determining a quantity of transport protocol packets of the second set of transport protocol packets that are received with an earlier arrival time via the secondary network path than the primary network path, wherein the quantity of transport protocol packets or a difference in arrival time, or both, satisfies a threshold.

Aspect 11: The method of any of aspects 1 through 10, further comprising: receiving an acknowledgement in response to the trigger signal, wherein the second set of transport protocol packets is received in accordance with the packet duplication based at least in part on the acknowledgement.

Aspect 12: The method of any of aspects 1 through 11, wherein receiving the second set of transport protocol packets comprises: receiving a first duplication of the second set of transport protocol packets via a primary network path; and receiving a second duplication of the second set of transport protocol packets via a secondary network path that is different from the primary network path.

Aspect 13: A first device for wireless communications, comprising a processing system that includes processor circuitry and memory circuitry that stores code, the processing system configured to cause the first device to perform a method of any of aspects 1 through 12.

Aspect 14: A first device for wireless communications, comprising at least one means for performing a method of any of aspects 1 through 12.

Aspect 15: A non-transitory computer-readable medium storing code for wireless communications, the code comprising instructions executable by one or more processors to perform a method of any of aspects 1 through 12.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first device, comprising:
a processing system that includes processor circuitry and memory circuitry that stores code, the processing system configured to cause the first device to:
receive, from a second device, a first set of transport protocol packets during a time window;
transmit, to the second device, a trigger signal for packet duplication based at least in part on a trigger to start or stop the packet duplication associated with the time window; and
receive, from the second device, a second set of transport protocol packets in accordance with the packet duplication based at least in part on the trigger signal.

2. The first device of claim 1, wherein the processing system is further configured to cause the first device to:
detect the trigger to start or stop the packet duplication based at least in part on one or more of a packet loss ratio of the first set of transport protocol packets received during the time window satisfying a first threshold, a latency metric of the first set of transport protocol packets received the time window satisfying a second threshold, or a jitter metric of the first set of transport protocol packets received during the time window satisfying a third threshold.

3. The first device of claim 1, wherein the processing system is further configured to cause the first device to:
measure one or more metrics associated with starting the packet duplication over a sliding time window when the packet duplication is not activated, wherein the trigger to start the packet duplication is based at least in part on the one or more metrics.

4. The first device of claim 1, wherein the processing system is further configured to cause the first device to:
measure one or more metrics associated with stopping the packet duplication over a sliding time window when the packet duplication is activated, wherein the trigger to stop the packet duplication is based at least in part on the one or more metrics.

5. The first device of claim 1, wherein the processing system is further configured to cause the first device to:
transmit a second trigger signal to stop the packet duplication based at least in part on a second trigger associated a second time window, wherein the second set of transport protocol packets are received during the second time window.

6. The first device of claim 5, wherein the processing system is further configured to cause the first device to:
detect the second trigger based at least in part on one or more of a decrease to a packet loss ratio failing to satisfy a first threshold during the second time window, a decrease to a latency metric failing to satisfy a second threshold during the second time window, or a decrease to a jitter metric failing to satisfy a third threshold during the second time window.

7. The first device of claim 6, wherein one or more of the packet loss ratio, the latency metric, and the jitter metric for a packet of the second set of transport protocol packets is based at least in part on an earlier arrival between the packet received via a primary network path and a duplicate of the packet received via a secondary network path.

8. The first device of claim 5, wherein the processing system is further configured to cause the first device to:
determine, for a first duplication of the second set of transport protocol packets associated with a primary network path, a first set of metrics associated with the primary network path based at least in part on the packet duplication;
determine, for a second duplication of the second set of transport protocol packets associated with a secondary network path, a second set of metrics associated with the secondary network path based at least in part on the packet duplication; and
detect the second trigger based at least in part on the first set of metrics and the second set of metrics.

9. The first device of claim 8, wherein, to detect the second trigger, the processing system is configured to cause the first device to:
determine a quantity of transport protocol packets of the second set of transport protocol packets that are successfully received via the secondary network path and not the primary network path.

10. The first device of claim 8, wherein, to detect the second trigger, the processing system is configured to cause the first device to:
determine a quantity of transport protocol packets of the second set of transport protocol packets that are received with an earlier arrival time via the secondary network path than the primary network path, wherein the quantity of transport protocol packets or a difference in arrival time, or both, satisfies a threshold.

11. The first device of claim 1, wherein the processing system is further configured to cause the first device to:
receive an acknowledgement in response to the trigger signal, wherein the second set of transport protocol packets is received in accordance with the packet duplication based at least in part on the acknowledgement.

12. The first device of claim 1, wherein, to receive the second set of transport protocol packets, the processing system is configured to cause the first device to:
receive a first duplication of the second set of transport protocol packets via a primary network path; and
receive a second duplication of the second set of transport protocol packets via a secondary network path that is different from the primary network path.

13. A method for wireless communications at a first device, comprising:
receiving, from a second device, a first set of transport protocol packets during a time window;
transmitting, to the second device, a trigger signal for packet duplication based at least in part on a trigger to start or stop the packet duplication associated with the time window; and
receiving, from the second device, a second set of transport protocol packets in accordance with the packet duplication based at least in part on the trigger signal.

14. The method of claim 13, further comprising:
detecting the trigger to start or stop the packet duplication based at least in part on one or more of a packet loss ratio of the first set of transport protocol packets received during the time window satisfying a first threshold, a latency metric of the first set of transport protocol packets received the time window satisfying a second threshold, or a jitter metric of the first set of transport protocol packets received during the time window satisfying a third threshold.

15. The method of claim 13, further comprising:
measuring one or more metrics associated with starting the packet duplication over a sliding time window when the packet duplication is not activated, wherein the trigger to start the packet duplication is based at least in part on the one or more metrics.

16. The method of claim 13, further comprising:
measuring one or more metrics associated with stopping the packet duplication over a sliding time window when the packet duplication is activated, wherein the trigger to stop the packet duplication is based at least in part on the one or more metrics.

17. The method of claim 13, further comprising:
transmitting a second trigger signal to stop the packet duplication based at least in part on a second trigger associated a second time window, wherein the second set of transport protocol packets are received during the second time window.

18. The method of claim 17, further comprising:
detecting the second trigger based at least in part on one or more of a decrease to a packet loss ratio failing to satisfy a first threshold during the second time window, a decrease to a latency metric failing to satisfy a second threshold during the second time window, or a decrease to a jitter metric failing to satisfy a third threshold during the second time window.

19. The method of claim 18, wherein one or more of the packet loss ratio, the latency metric, and the jitter metric for a packet of the second set of transport protocol packets is based at least in part on an earlier arrival between the packet received via a primary network path and a duplicate of the packet received via a secondary network path.

20. A non-transitory computer-readable medium storing code for wireless communications, the code comprising instructions executable by one or more processors to:
receive, from a second device, a first set of transport protocol packets during a time window;
transmit, to the second device, a trigger signal for packet duplication based at least in part on a trigger to start or stop the packet duplication associated with the time window; and
receive, from the second device, a second set of transport protocol packets in accordance with the packet duplication based at least in part on the trigger signal.
